(19) United States
(12) Patent Application Publication
(10) Pub. No.: US 2026/0240399 A1
(43) Pub. Date: Aug. 20, 2026

(54) FOLDABLE HANDHELD MAGNETIC SWEEPER APPARATUS

(71) Applicant: Bluestreak Equipment Inc., Delhi (CA)

(72) Inventors: Brian WEBER, Delhi (CA); Shuyue ZHANG, Delhi (CA); John MAGUIRE, Delhi (CA)

(21) Appl. No.: 19/545,061

(22) Filed: Feb. 20, 2026

Related U.S. Application Data
(60) Provisional application No. 63/760,790, filed on Feb. 20, 2025.

(51) Int. Cl. A47L 13/41; A47L 13/42; B25G 1/04; B25G 1/06; H01F 7/02

(52) U.S. Cl. CPC A47L 13/41; A47L 13/42; B25G 1/04; B25G 1/06; H01F 7/0205

(57) ABSTRACT

A foldable handheld portable magnetic sweeper apparatus that folds into a collapsed position for storage and folds into an extended position for use. The apparatus includes a quick clean-off sleeve configured to be removable, installed over a magnetic collection portion to enable safe debris release, an ergonomic extendable handle adjustable for different operator heights, connector assemblies enabling folding and angular adjustment secured by a nut-and-bolt arrangement, and in some embodiments an internal containment housing configured to maintain positional stability of rare earth or ceramic magnets after magnetization.

### CROSS-REFERENCE TO RELATED APPLICATIONS

This application claims priority to U.S. Provisional Patent Application No. 63/760,790, filed Feb. 20, 2025, titled “FOLDABLE HANDHELD MAGNETIC SWEEPER APPARATUS”, which is herein incorporated by reference.

### BACKGROUND

The field of the disclosure relates to magnetic cleaning apparatus, in particular to a portable magnetic sweeper apparatus.

A portable magnetic sweeper apparatus (such as the Powerstik) can be used to collect metal debris on the lower portion of the sweeper handle body. However, there may be some deficiencies with this design. For example, when users want to remove the metal debris from the tool, it can be hazardous for human hands to remove the sharp debris requiring the need for gloves or other protective gear and slows down the process.

Furthermore, using the portable magnetic sweeper apparatus (e.g., Powerstik) aluminum handle body on abrasive surfaces, causes the aluminum to wear out allowing the magnetic core to separate from it and the product is then no longer usable.

The magnet assembly of the portable magnetic sweeper apparatus may not be strong enough to meet certain users'requirements. Furthermore, the hand grip of certain portable magnetic sweeper apparatus may not be comfortable for long periods of use, and it has been mentioned that the product is too short for some operators.

Existing portable magnetic sweeper apparatus may be one piece design and may be large and clunky and not easily stored.

There is a desire to create a portable magnetic sweeper apparatus that addresses some of these deficiencies.

### BRIEF DESCRIPTION OF THE DRAWINGS

FIG. 1 is a diagram of an exemplary foldable portable magnetic sweeper apparatus in an extended/deployed configuration.

FIG. 2 is a diagram of the exemplary foldable portable magnetic sweeper apparatus with a clean-off sleeve and grip rest.

FIG. 3 is a diagram that shows the apparatus in a folded configuration.

FIG. 4 is a diagram of a close-up view of the connector assembly.

FIG. 5 is a diagram of an exploded view of the connector assembly.

FIG. 6 is a diagram of an internal rare earth containment housing.

FIG. 7 is a diagram illustrating the handle and the handle adjustment mechanism.

FIG. 8 is a diagram illustrating the sleeve release button.

### SUMMARY

A foldable handheld portable magnetic sweeper apparatus. The apparatus folds down into a collapsed closed position for storage and shipping. It can be quickly and easily folded or open into an open extended position for use. The foldable magnetic cleaning apparatus comprises a quick clean off sleeve, a handle body, an ergonomic and extendable handle, two connector assemblies and an internal magnet assembly, either using rare earth or ceramic magnets, and with or without a containment housing. The connector assembly allows the apparatus to adjust to a wide range of angles and be secured in place with the adjustable nut and bolt. The sleeve slips on and off easily to easily clean off debris. The ergonomic and extendable handle slides on over main magnet tube housing to reduce operator strain and fatigue and accommodate operators of different heights.

The internal magnet assembly consists of a set of rare earth or ceramic magnets and an internal plastic housing to hold the magnets in place, allowing them to be charged as an assembly and then safely handled by the user. The housing is required for rare earth magnet assembly to holds the rare earth magnets in a proximity to each other that would otherwise push apart/rotate/attract them to each other after magnetization. It is optional for ceramic magnet assembly, since their lower strength and larger size allow them to be handled easily.

### DETAILED DESCRIPTION

This disclosure relates to a foldable handheld portable magnetic sweeper apparatus configured to be transitioned between an extended/deployed configuration for collecting ferromagnetic debris and a collapsed/folded configuration for storage and shipping.

This disclosure addresses shortcomings of existing portable magnetic sweepers (e.g., rigid one-piece configurations) that do not store easily and may be hazardous or inconvenient when removing collected sharp debris.

The apparatus improves upon conventional portable magnetic sweepers that are typically rigid, one-piece designs that can be large/clunky to store and may present safety and durability concerns (e.g., hazardous debris removal, and wear of an aluminum body during abrasive use that can lead to separation of a magnetic core).

In an embodiment, a foldable portable magnetic sweeper apparatus (e.g., “Powerstik Flex”) folds down into a collapsed/closed position for storage/shipping and folds open into an extended position for use.

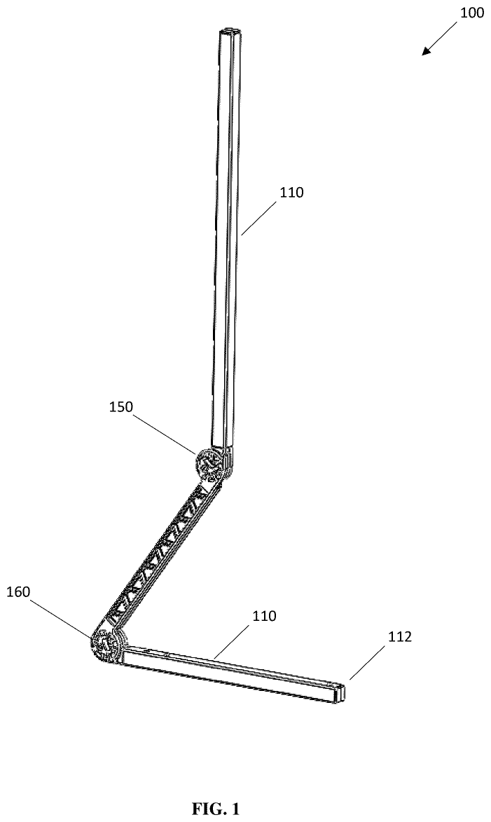

FIG. 1 is a diagram of an exemplary foldable portable magnetic sweeper apparatus in an extended/deployed configuration. According to FIG. 1, an exemplary foldable portable magnetic sweeper apparatus in an extended/deployed configuration suitable for use is shown. In this configuration, the handle body extends generally linearly and positions the magnetic collection portion near a surface for debris collection. The extendable handle is shown coupled to the handle body and arranged for operator use. Connector assemblies are shown in an open state to provide the deployed configuration.

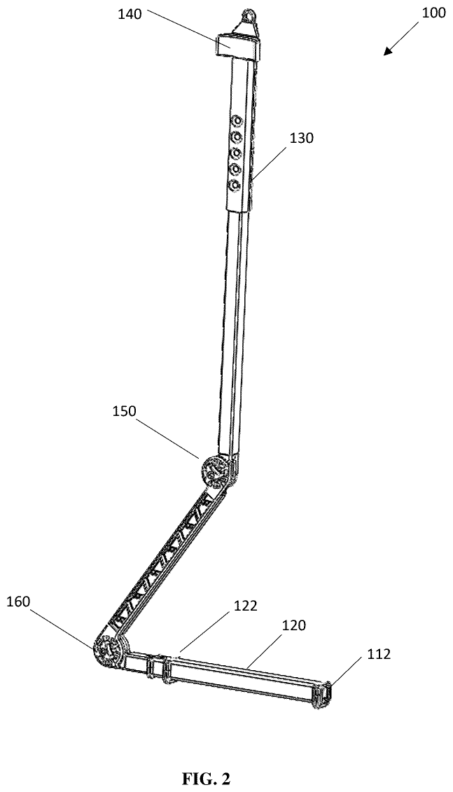

FIG. 2 is a diagram of the exemplary foldable portable magnetic sweeper apparatus with a clean-off sleeve and grip rest. According to FIG. 2, the apparatus in an extended configuration with the quick clean-off sleeve installed over the magnetic collection portion and with a grip rest positioned for improved ergonomics is shown. The sleeve may be retained by a push-button mechanism and may include wear bars for abrasion resistance. The grip rest provides a support region for the user's hand to reduce fatigue during operation.

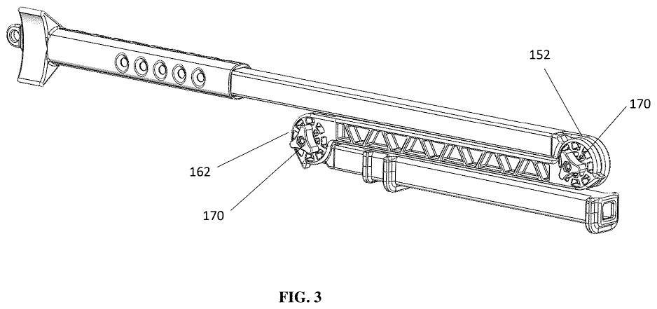

FIG. 3 is a diagram that shows the apparatus in a folded configuration. According to FIG. 3, the apparatus in a folded configuration for storage or shipping is shown. In this configuration, the handle body segments are folded relative to each other via the connector assemblies such that the overall length/footprint is reduced relative to the deployed configuration.

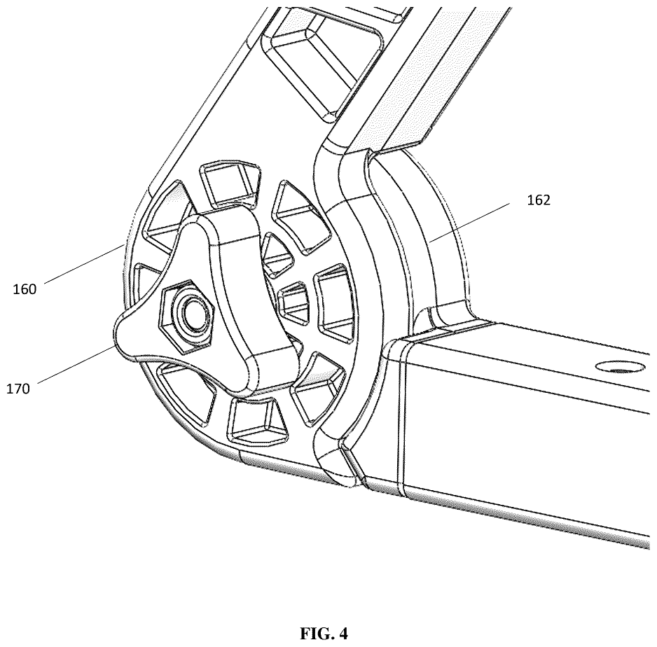

FIG. 4 is a diagram of a close-up view of the connector assembly. According to FIG. 4, the connector may include two mating parts with complementary engagement features (e.g., grooves) and a fastener arrangement (e.g., nut and bolt) configured to clamp the parts together to lock the connector at a selected angle, enabling angle adjustment during use and enabling folding for storage.

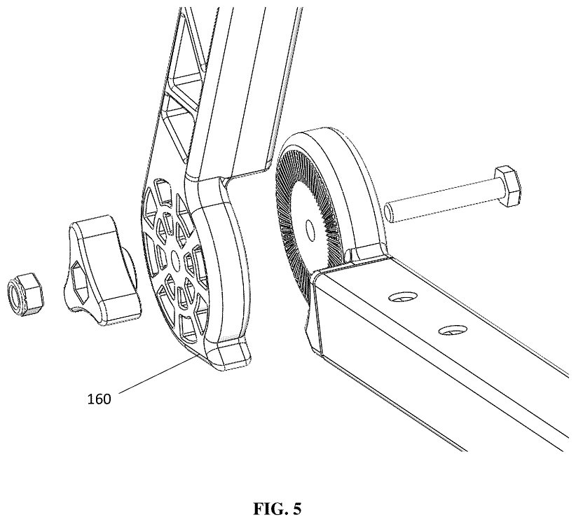

FIG. 5 is a diagram of an exploded view of the connector assembly. According to FIG. 5, an exploded view of the connector assembly, showing the relationship between first and second connector portions, the grooved engagement surfaces, and the fastener arrangement that secures the connector portions together when assembled is shown. This view supports embodiments where tightening the nut and bolt increases friction and/or interlocking engagement to resist rotation at the selected angle.

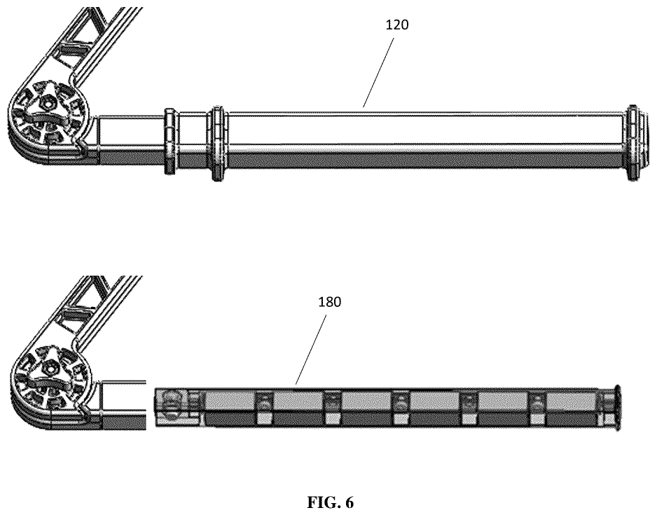

FIG. 6 is a diagram of an internal rare earth containment housing. FIG. 6 illustrates an internal rare earth containment housing configured to be received inside the apparatus housing to maintain the position of rare earth magnets after magnetization and to inhibit magnet movement that could otherwise occur due to magnetic forces (e.g., pushing apart, rotation, or attraction-driven movement).

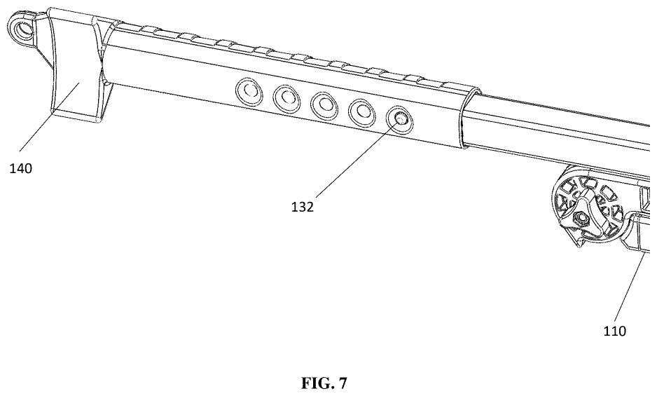

FIG. 7 is a diagram illustrating the handle and the handle adjustment mechanism.

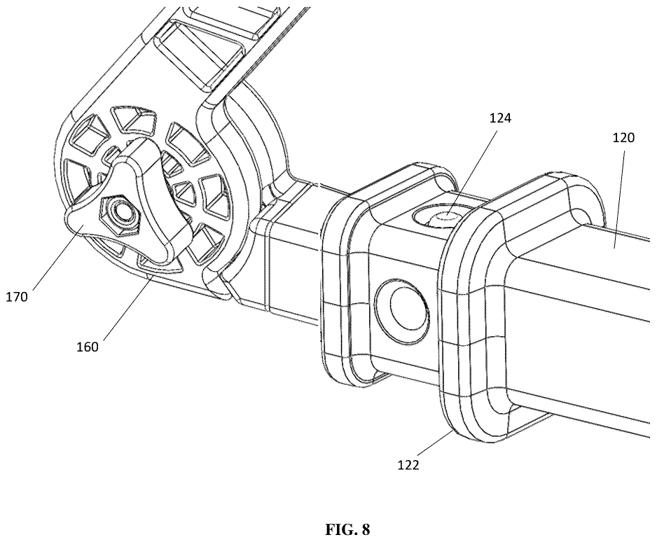

FIG. 8 is a diagram illustrating the sleeve release button.

### Exemplary Structure

For clarity, exemplary (non-limiting) reference numerals are introduced:
Apparatus 100
Handle body/magnet tube housing 110
Magnetic assembly 112 (rare earth and/or ceramic magnets)
Quick clean-off sleeve 120
Sleeve wear bars 122
Sleeve retention/release mechanism (e.g., push button) 124
Ergonomic/extendable handle 130
Handle adjustment mechanism (e.g., push button) 132
Grip rest 140
Upper connector assembly 150
Lower connector assembly 160
Connector grooves/indexing features 152, 162
Adjustable fastener set (bolt/nut) 170
Internal rare earth containment housing 180

These numerals are provided for drafting convenience and may be aligned to your final drawing callouts during formal figure markup.

### Handle Body and Magnetic Collection Portion

In embodiments, the apparatus includes a handle body (110) that defines or supports a magnetic collection portion positioned to be swept proximate to a ground surface, floor, roadway, shop area, job site, or other region where ferromagnetic debris is present. The magnetic collection portion includes a magnet assembly (112) that may be implemented using rare earth magnets and/or ceramic magnets, depending on performance and cost targets.

In some embodiments, at least a portion of the handle body comprises an aluminum magnetic sweeper housing, which may be susceptible to wear when used on abrasive surfaces; the quick clean-off sleeve described below can provide protective wear functionality over the aluminum housing.

### Quick Clean-Off Sleeve

In embodiments, the apparatus includes a quick clean-off sleeve (120) configured to allow a user to safely remove collected metal debris. The sleeve may be a four-sided plastic sleeve that is held on and released via a push button mechanism (124). The sleeve may include built-in wear bars to extend the life of an underlying aluminum magnetic sweeper housing it covers. The sleeve is configured to slip on and off easily, and in some implementations may cause debris to come off the end in a single pile, reducing debris spread and reducing user handling.

The following are steps involved in debris removal operation:
During sweeping, ferromagnetic debris accumulates on the outside of the sleeve while the magnet assembly underneath provides the attractive force through the sleeve.
When the user wishes to dispose of collected debris, the user actuates the push button (or other release) and removes/slides the sleeve relative to the handle body.
Once the sleeve is displaced/removed, the debris is no longer held in the same manner and can be released—optionally as a more concentrated pile (e.g., “debris comes off the end in one pile”), reducing scatter and minimizing direct hand contact with sharp debris.

According to the disclosure, the sleeve may include built-in wear bars (122) configured to extend the life of the underlying magnetic sweeper housing (e.g., aluminum) by taking abrasion instead of the housing itself.

According to the disclosure, a removable sleeve, such as friction-fit, latch, detent, clip, or other retention features, provided they enable quick removal to release debris can be used.

### Internal Magnet Containment Housing

In embodiments, the apparatus includes an internal magnet containment housing (180), mainly for the rare earth magnets, described as an internal plastic device configured to allow magnets to be charged as an assembly and then safely handled (e.g., during manufacturing).

The containment housing is configured to be placed within the product housing and remain there to:
maintain magnet position, and
prevent magnets from coming out, and/or
inhibit magnet behavior after magnetization (e.g., rare earth magnets that are small in size but strong in magnetic force would otherwise push apart, rotate, or attract to each other after magnetization).

According to the disclosure, the housing is placed inside the body of the product and remains there to maintain magnet position and prevent magnets from migrating or coming out. The housing holds rare earth magnets in proximity that would otherwise cause them to push apart, rotate, or attract to each other after magnetization. Ceramic magnets may be used with or without a containment housing.

### Ergonomic and Extendable Handle and Grip Rest

In embodiments, the apparatus includes an ergonomic and extendable handle (130) described as a plastic handle part that slides on over the handle body to reduce operator strain/fatigue and to accommodate operators of different heights.

A push button mechanism (132) may be provided to change the handle position among multiple settings (e.g., to vary effective handle length or grip location).

A grip rest (140) may additionally be provided for operating comfort, fatigue reduction and improved control.

### Connector Assemblies; Folding and Angle Adjustment

In embodiments, the apparatus includes two connector assemblies enabling folding/storage and angle adjustment. Each connector assembly may be a two-piece connector assembly with grooves (152, 162) and held together with an adjustable nut and bolt (170) to secure an angle. The uppermost connector may have an angular range of about 0 to 150 degrees, and the lower connector may have an angular range of about 0 to 60 degrees (ranges may vary by design).

The connector assembly materials may include plastic, metal, and/or aluminum. In one example, the extended apparatus is about 49 inches tall×18 inches wide×2.1 inches deep, and the folded apparatus is about 36 inches long×5 inches wide×2.1 inches deep (dimensions may vary).

### Additional Embodiments

The features described herein may be combined in various ways. For example, the sleeve may be used with differing retention/release mechanisms; the containment housing may be adapted to different magnet arrays; and connector assemblies may include detents, indexing features, or frictional clamping surfaces.

According to the disclosure, a foldable handheld magnetic sweeper apparatus is disclosed. The foldable handheld magnetic sweeper apparatus comprises a handle body including a magnetic collection portion configured to attract ferromagnetic debris, a quick clean-off sleeve configured to be removable, wherein removal of the quick clean-off sleeve releases debris collected on the magnetic collection portion, an extendable handle coupled to the handle body and is adjustable to accommodate operators of different heights, an upper connector assembly and a lower connector assembly arranged to permit the apparatus to transition between an extended use configuration and a folded storage configuration, and a fastener arrangement associated with at least one of the upper connector assembly or the lower connector assembly and configured to secure an angular position of the apparatus.

According to the disclosure, the quick clean-off sleeve comprises a four-sided sleeve and a polymeric material. The quick clean-off sleeve includes wear bars configured to protect an underlying housing of the handle body from abrasion. The quick clean-off sleeve is configured, upon removal, to cause the debris to be released as a concentrated pile from an end region of the magnetic collection portion.

According to the disclosure, the apparatus further comprises a push-button retention mechanism configured to retain the quick clean-off sleeve on the handle body and selectively release the sleeve. The extendable handle of the apparatus comprises a sleeve-like grip member that slides over the handle body.

According to the disclosure, the magnetic collection portion of the apparatus includes one or more rare earth magnets. The magnetic collection portion further comprises an internal containment housing placed within the handle body and configured to maintain a positional relationship among the one or more rare earth magnets.

According to the disclosure, the internal containment housing comprises a polymeric structure configured to inhibit rotation and separation of the one or more rare earth magnets after magnetization. The magnetic collection portion may also include one or more ceramic magnets and the one or more ceramic magnets are either inserted into the body directly, or inserted within an internal containment housing.

According to the disclosure, the apparatus further comprises a push-button adjustment mechanism configured to lock the extendable handle in a selected position and a grip rest positioned to support a hand of a user during operation.

According to the disclosure, the upper connector assembly or the lower connector assembly comprises a two-piece connector having complementary grooved surfaces and wherein the complementary grooved surfaces are configured to provide angular indexing. The upper connector assembly provides an angular adjustment range of about 0 degrees to about 150 degrees and the lower connector assembly provides an angular adjustment range of about 0 degrees to about 60 degrees.

According to the disclosure, the upper connector assembly and the lower connector assembly cooperatively enable folding of the apparatus into a collapsed configuration for storage. According to the disclosure, in the extended use configuration the apparatus has an overall height of about 49 inches and an overall width of about 18 inches and wherein in the folded storage configuration the apparatus has an overall length of about 36 inches and an overall width of about 5 inches.

According to the disclosure, the fastener arrangement of the apparatus comprises a bolt and a nut configured to clamp the connector assembly at the angular position. The portion of the handle body can be comprised of aluminum and at least one connector assembly comprises plastic, metal, or aluminum.

According to the disclosure, a connector assembly for a foldable handheld magnetic sweeper apparatus is disclosed. The foldable handheld magnetic sweeper apparatus comprises a first connector member and a second connector member configured to couple two elongate portions of the apparatus, complementary engagement features on the first connector member and the second connector member configured to resist relative rotation when clamped and a nut-and-bolt fastener arrangement configured to compress the first connector member and the second connector member together to lock an angular position between the two elongate portions.

According to the disclosure, the complementary engagement features comprise grooves. The connector assembly is configured to provide an angular adjustment range of at least 60 degrees on the lower section and provide an angular adjustment range of up to about 150 degrees on the upper section.

According to the disclosure, a method of collecting and removing ferromagnetic debris using a foldable handheld magnetic sweeper apparatus. The method comprising the steps of attracting ferromagnetic debris to a magnetic collection portion of the apparatus while a removable sleeve covers the magnetic collection portion, positioning the magnetic collection portion above the recycling area/container and removing the sleeve from the magnetic collection portion to release the debris into the recycling area/container.

According to the disclosure, an internal containment housing for a magnetic sweeper apparatus is disclosed. The internal containment housing comprises a polymeric body configured to be received within a handle body of the magnetic sweeper apparatus and several magnet-receiving features configured to maintain a positional relationship among a set of rare earth or ceramic magnets after magnetization and inhibit at least one of rotation, separation, or mutual attraction-driven movement of the magnets.

While some embodiments or aspects of the present disclosure may be implemented in fully functioning mechanical, electrical and electrical-mechanical systems, other embodiments may be considered.

The specific embodiments described above have been shown by way of example and understood is that these embodiments may be susceptible to various modifications and alternative forms. Further understood is that the claims are not intended to be limited to the forms disclosed, but to cover all modifications, equivalents, and alternatives falling within the spirit and scope of this disclosure. While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, various changes and modifications in form, material, workpiece, and fabrication material detail may be made, without departing from the spirit and scope of the present disclosure, as set forth in the appended claims, as may be apparent to those of ordinary skill in the art, are also encompassed by the present disclosure.

What this claimed is:

1. A foldable handheld magnetic sweeper apparatus comprising:
a handle body including a magnetic collection portion configured to attract ferromagnetic debris;
a quick clean-off sleeve configured to be removable, wherein removal of the quick clean-off sleeve releases debris collected on the magnetic collection portion;
an extendable handle coupled to the handle body and is adjustable to accommodate operators of different heights;
an upper connector assembly and a lower connector assembly arranged to permit the apparatus to transition between an extended use configuration and a folded storage configuration; and
a fastener arrangement associated with at least one of the upper connector assembly or the lower connector assembly and configured to secure an angular position of the apparatus.

2. The apparatus of claim 1, wherein the quick clean-off sleeve comprises a four-sided sleeve.

3. The apparatus of claim 1, wherein the quick clean-off sleeve comprises a polymeric material.

4. The apparatus of claim 1, wherein the quick clean-off sleeve includes wear bars configured to protect an underlying housing of the handle body from abrasion.

5. The apparatus of claim 1, further comprising a push-button retention mechanism configured to retain the quick clean-off sleeve on the handle body and selectively release the sleeve.

6. The apparatus of claim 1, wherein the quick clean-off sleeve is configured, upon removal, to cause the debris to be released as a concentrated pile from an end region of the magnetic collection portion.

7. The apparatus of claim 1, wherein the magnetic collection portion includes one or more rare earth magnets.

8. The apparatus of claim 7, further comprising an internal containment housing placed within the handle body and configured to maintain a positional relationship among the one or more rare earth magnets.

9. The apparatus of claim 8, wherein the internal containment housing comprises a polymeric structure configured to inhibit rotation and separation of the one or more rare earth magnets after magnetization.

10. The apparatus of claim 1, wherein the magnetic collection portion includes one or more ceramic magnets and the one or more ceramic magnets are either inserted into the body directly, or inserted within an internal containment housing.

11. The apparatus of claim 1, wherein the extendable handle comprises a sleeve-like grip member that slides over the handle body.

12. The apparatus of claim 11, further comprising:
a push-button adjustment mechanism configured to lock the extendable handle in a selected position; and
a grip rest positioned to support a hand of a user during operation.

13. The apparatus of claim 1, wherein the upper connector assembly or the lower connector assembly comprises a two-piece connector having complementary grooved surfaces and wherein the complementary grooved surfaces are configured to provide angular indexing.

14. The apparatus of claim 1, wherein the upper connector assembly provides an angular adjustment range of about 0 degrees to about 150 degrees and the lower connector assembly provides an angular adjustment range of about 0 degrees to about 60 degrees.

15. The apparatus of claim 1, wherein the upper connector assembly and the lower connector assembly cooperatively enable folding of the apparatus into a collapsed configuration for storage.

16. The apparatus of claim 1, wherein in the extended use configuration the apparatus has an overall height of about 49 inches and an overall width of about 18 inches and wherein in the folded storage configuration the apparatus has an overall length of about 36 inches and an overall width of about 5 inches.

17. A connector assembly for a foldable handheld magnetic sweeper apparatus, comprising:
a first connector member and a second connector member configured to couple two elongate portions of the apparatus;
complementary engagement features on the first connector member and the second connector member configured to resist relative rotation when clamped; and
a nut-and-bolt fastener arrangement configured to compress the first connector member and the second connector member together to lock an angular position between the two elongate portions.

18. The connector assembly of claim 17, wherein the complementary engagement features comprise grooves.

19. The connector assembly of claim 17, wherein the connector assembly is configured to:
provide an angular adjustment range of at least 60 degrees on the lower section; and
provide an angular adjustment range of up to about 150 degrees on the upper section.

20. A method of collecting and removing ferromagnetic debris using a foldable handheld magnetic sweeper apparatus, the method comprising the steps of:
attracting ferromagnetic debris to a magnetic collection portion of the apparatus while a removable sleeve covers the magnetic collection portion;
positioning the magnetic collection portion above the recycling area; and
removing the sleeve from the magnetic collection portion to release the debris into the recycling area.
